(19) United States
(12) Patent Application Publication
(10) Pub. No.: US 2023/0351411 A1
(43) Pub. Date: Nov. 2, 2023

(54) CROWDSOURCING INFORMATION TO CLEANSE RAW DATA

(71) Applicant: Capital One Services, LLC, McLean, VA (US)

(72) Inventors: Max Miracolo, Brooklyn, NY (US); Sophie Bermudez, Dartmouth, MA (US); Leeyat Bracha Tessler, Arlington, VA (US); Anne Scharmann, Washington, DC (US); Sarah Olsen, Springfield, VA (US)

(21) Appl. No.: 17/730,733

(22) Filed: Apr. 27, 2022

(51) Int. Cl. G06Q 30/00; G06F 16/215; G06N 5/04

(52) U.S. Cl. CPC G06Q 30/0185; G06F 16/215; G06N 5/046

(57) ABSTRACT

Disclosed embodiments may relate to crowdsourcing updated information based on raw transaction data. A set of candidate merchant data that matches raw merchant data associated with a customer's purchase transaction may be inferred using a machine learning model. The merchant data may comprise merchant name, postal code, state, city, or merchant category code. An electronic purchase alert may be generated that requests the customer to identify merchant data from the candidate merchant data associated with the purchase transaction. The electronic purchase alert may be transmitted to a customer within a predetermined time after the transaction. The purchase alert is accessible to the customer through a computing device. Further, the machine learning model may be retrained after a predetermined time with the raw merchant data and identified merchant data associated with the transaction and additional transactions.

### BACKGROUND

Information transfers may be logged automatically. For example, to maintain a record of transfers from a user may be logged with the item to be transferred as well as an identifier of who received the transfer. The identifier about the recipient of the transfer may be generated automatically based on system data. However, automatic generation of the identifiers are often incorrect or not comprehendible to be recognizable to a user or system. may

### SUMMARY

The following presents a simplified summary to provide a basic understanding of some aspects of the disclosed subject matter. This summary is not an extensive overview. It is not intended to delineate the scope of the claimed subject matter. This description is intended to present some concepts in a simplified form as a prelude to the more detailed description presented later.

The subject disclosure pertains to systems, methods, and computer program products relating to crowdsourcing information to cleanse raw transaction data. In some embodiments, a system of cleansing raw data based on feedback is provided. The system can comprise a processor coupled to a memory that includes instructions that, when executed by the processor, can cause the processor to identify raw merchant data that comprises a raw merchant name associated with a transaction of a user, wherein the raw merchant name is obscure; infer a set of candidate merchant names that match the raw merchant name with a predetermined level of confidence with a machine learning model; generate an electronic alert for the user to select a merchant name from the set of candidate merchant names associated with the transaction; transmit the electronic alert to a device of the user within a predetermined time of the transaction; receive an identified merchant name from the device of the user; save the raw merchant name and the identified merchant name as training data; and generate, after a predetermined period of time, an instruction to update the machine learning model based on the training data.

According to some embodiments, a crowdsourcing method of raw transaction data cleansing is provided. The method comprises executing, on a processor, instructions that cause the processor to perform operations associated with data cleansing. The operations include inferring, with a machine learning model, a set of candidate merchant names that match a raw merchant name with a predetermined level of confidence, wherein the raw merchant name is an obscure name; generating an electronic alert that requests the user identify a merchant name from the set of candidate merchant names associated with the purchase transaction; transmitting the electronic alert to a device of the user within a predetermined time after the transaction; and updating the machine learning model after a predetermined time with the raw merchant name and identified merchant name.

A crowdsourcing method of cleansing raw merchant data is provided in some embodiments. The method comprises inferring, with a machine learning model, a set of candidate merchant data that match raw merchant data associated with a purchase transaction of a user with a predetermined level of confidence; generating an electronic alert that requests the user identify merchant data from the set of candidate merchant data associated with the purchase transaction; transmitting the electronic alert to a device of the user within a predetermined time after the transaction; and triggering an update of the machine learning model after a predetermined time with the raw merchant data and identified merchant data. The crowdsourcing method further comprises monitoring a number of times different customers specify the identified merchant data for the raw merchant data, determine that the number of times satisfies a threshold, overriding the machine learning model, and returning the identified merchant data for the raw merchant data for confirmation before the retraining of the machine learning model. Further, the crowdsourcing method can comprise adding the identified merchant name on a statement of transactions for the customer.

To the accomplishment of the foregoing and related ends, certain illustrative aspects of the subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation in accordance with one or more embodiments described herein.

FIG. 2 illustrates a block diagram of an example, non-limiting data labeling system in accordance with one or more embodiments described herein.

FIG. 3 illustrates a block diagram of another example, non-limiting data labeling system in accordance with one or more embodiments described herein.

FIG. 4 illustrates an example, non-limiting mobile credit card notification in accordance with one or more embodiments described herein.

FIG. 5 illustrates an example, non-limiting merchant information form in accordance with one or more embodiments described herein.

FIG. 6 illustrates an example, non-limiting transaction history in accordance with one or more embodiments described herein.

FIG. 7 illustrates an example, non-limiting transaction details in accordance with one or more embodiments described herein.

FIG. 8 illustrates another example, non-limiting transaction details in accordance with one or more embodiments described herein.

FIG. 9 illustrates another example, non-limiting transaction details in accordance with one or more embodiments described herein.

FIG. 10 illustrates another example, non-limiting transaction details in accordance with one or more embodiments described herein.

FIG. 11 illustrates another example, non-limiting transaction details in accordance with one or more embodiments described herein.

FIG. 12 illustrates another example, non-limiting transaction history in accordance with one or more embodiments described herein.

FIG. 13 illustrates another example, non-limiting transaction details in accordance with one or more embodiments described herein.

FIG. 14 illustrates another example, non-limiting transaction details in accordance with one or more embodiments described herein.

FIG. 15 illustrates a flow diagram of an example, non-limiting computer-implemented method in accordance with one or more embodiments described herein.

FIG. 16 illustrates another flow diagram of an example, non-limiting computer-implemented method in accordance with one or more embodiments described herein.

FIG. 17 illustrates a flow diagram of an example, non-limiting computer-implemented method in accordance with one or more embodiments described herein.

FIG. 18 is a block diagram illustrating a suitable operating environment for aspects of the subject disclosure.

### DETAILED DESCRIPTION

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

Displaying raw (e.g., uncleansed) transaction data that does not describe the merchant or the transaction may lead to an increase in call volumes to call centers because customers sometimes do not recognize their credit card transactions (e.g., purchase transactions). Confusions in merchant names contribute to fraud claims. A high cost (e.g., $50+ million) is associated with processing call center calls to report false fraud claims. The cost is the consequence of providing raw transaction data containing confusing merchant names, different authorization and swipe dates, bundled authorization amounts, forgotten subscriptions and trials, multiple users on an account, and recognized merchants with unrecognized charges. As shown in raw transaction data, merchant names commonly have numbers and asterisks, making the merchant and ear.

Initially, upon a credit card purchase transaction, raw (e.g., uncleansed) merchant data is received by a financial institution as it was processed through a payment terminal, which may be cryptic and provide limited information. Raw merchant data may comprise merchant name, postal code, state, city, merchant category code (MCC), and country. Raw merchant names may be unclear or obscure in terms of accurately or easily identifying the merchant. For example, raw merchant names may include numbers and asterisks that obscures the identity of the merchant, provides limited value to the customers, and may causes confusion. A multi-stage algorithm with deterministic rules and machine learning techniques may be used to match raw transaction data (e.g., raw merchant data) to merchant candidates or a set of candidate names (e.g., potential matches of the cleansed and enhanced merchant information).

The merchant candidates or set of candidate merchant names may be displayed or shown to the customers through digital servicing (e.g., digital channels, digital space, etc.) such as a web application, mobile application, push notification, text message, email, or a combination thereof. These digital channels may also be used for instant purchase alerts to detect fraud and unintentional charges. Instant purchase alerts may be sent right after (e.g., within seconds, within a predetermined amount of time, etc.) a purchase is made via a push notification from a mobile application, a text message, or an email (e.g., email notifications may be received via mobile phones and thus may be instantaneous). If the customers provide feedback that a merchant candidate has the correct merchant information, the merchant candidate may be considered cleansed and enhanced merchant information, in addition to being used to train and improve models. These enhancements (e.g., cleansed and enhanced merchant information) may also help customer service agents understand transaction details to better assist customers by answering questions regarding credit card charges.

However, it would be useful to obtain feedback on whether the merchant candidates shown to customers are correct. Financial institutions rely on customers calling customer service agents to complain about an issue to find out the wrong merchant information (e.g., merchant candidate) was shown. This may be a manual and unreliable process to gather feedback and catch errors.

With the assistance of machine learning, the standard for precision and accuracy of the matches is about 98%, which is considered high, and the likelihood of a false positive being returned is low. Nonetheless, considering that a financial institution may be processing about 20 billion transactions per month, a 98% precision threshold may still result in millions of potential false positives being shown to customers.

Attempts to cleanse raw transaction data are effective about 75% of the time, and transactions are left uncleansed about 25% of the time. In addition, about 9% of the merchant candidates do not meet the 98% precision threshold, and some 16% of the raw transaction data do not have merchant candidates. Merchant candidates that do not meet the 98% precision threshold are not shown to the customers and instead shown the raw transaction data. These merchant candidates with a confidence score below a threshold are discarded, and no merchant candidates are shown to customers. The merchant candidates that do not meet the standard for precision and accuracy needed to be shown to customers may be seen as missed opportunities because sometimes these discarded merchant candidates are matches.

While specific percentages are discussed herein, it is to be appreciated that these numbers are employed for illustration purposes and are not intended to limit the spirit and/or scope of the present disclosure in any manner. As such, other embodiments exist that employ differing percentages without departing from the scope of the detailed description and claims appended hereto.

Showing raw transaction data, e.g., without cleansed merchant information, may increase call volumes to call centers because customers do not recognize their purchases and are confused. There is a cost associated with calls made to call centers due to customers not recognizing a charge. Sometimes the customers will see something they do not recognize and immediately dispute the transaction or report fraud on something that is likely a legitimate transaction, but they do not recognize it because of how it is being displayed. Customers are increasingly reporting fraud and disputing transactions that are, in fact, legitimate. Raw transaction data may cause confusion, but a false positive may make a situation even worse. Showing an incorrect merchant name or incorrect merchant information such as a phone number, website, and address may cause alarm.

Embodiments herein may crowdsource merchant information to increase the percentage of cleansed data and reduce the number of false fraud alerts. The embodiments herein may utilize deep learning coupled with gradient boosting machines. Deep learning may be employed to identify new model features based on feedback crowdsourced from customers and customer service agents. Gradient boosting (e.g., gradient boosting machines), a supervised machine learning technique that utilizes regression algorithms and classification algorithms, may be used to generate models comprising one or more merchant candidates to match with the raw merchant data.

Feedback crowdsourced from customers may also be used to retrain the models. For transactions with merchant candidates that do not meet the precision threshold of 98%, the top merchant candidates (e.g., a predetermined number of merchant candidates) having the highest model score (e.g., confidence score) of 0.8 or above may be displayed to the customers to select, in a multiple choice format, the merchant candidate that matches the raw transaction data. For example, customers viewing their transactions may select to see more details. The additional details may display merchant candidates and ask customers to select the merchant candidate that matches the merchant. Alternatively, they may select none of the above and add a merchant description. In addition to a multiple-choice question, the feedback may also come from a yes or no question. If there are no merchant candidates with a confidence score meeting the predetermined threshold of 0.8, an option to enter merchant information (e.g., freeform data entry) may accompany the raw transaction data shown. Additionally, customers may also be provided with options to report a problem. If a predetermined number of customers report a problem or select a certain merchant (e.g., submitted a certain merchant information), the output may be automatically updated to show that this is the matched merchant. This labeled match may also be used in the training dataset. As an interim before the model is updated or retrained, an override with deterministic logic may be used to automatically match the merchant candidate to the merchant, and the cache key may be automatically updated to show the correct merchant that the customers are providing feedback on.

To ease customer confusion, merchant candidates shown as labeled match, including merchant candidates with a 98% precision threshold, may indicate a lack of confidence that the correct merchant information is shown and provide customers with options to provide feedback. As confidence increases, the indication of lack of confidence may be removed. A labeled match may also be shown with options to provide feedback without indication of a lack of confidence because merchant information may change suddenly if there is a relocation or change of ownership. Having an option to crowdsource feedback on merchant information may be resourceful even if there is no lack of confidence because merchant information may change rapidly, especially with a relocation.

Customers may provide additional proof by uploading their receipts, which have transaction details and may include merchant information. Uploaded receipts containing transaction details (e.g., purchases, merchant information, method of payment, date, time, etc.) may increase confidence of customer feedback by analyzing and matching the transaction details on the receipts with the raw transaction data. Sharing geolocation may be another way to increase confidence of customer feedback. Shared location at time of purchase may be confirmed with the geographical data, if any, in the raw transaction data and the merchant's address provided by the customer in the feedback or searched in an online map. Customers that consistently provide accurate feedback may be given credit in their profile, which may mean higher confidence in their feedback. Having labeled transaction data from customers that have actually made the purchases may be very valuable. The labeling of training data may be outsourced to a third-party labeler (e.g., labeling company). However, there is a cost involved to pay for the labeled data, which may be in the hundreds of thousands of rows of data. Labeled data from labeling companies may also contain errors. Customer feedback may provide a cross-check and possibly real-time cross-check by employing instant purchase alerts on the accuracy of labeled data from labeling companies. Customer feedback may be used to modify model scores of merchant candidates as well as labeled data from third-party labeling companies. For example, selections such as none of the above by customers may lower the confidence score of the merchant candidates that were presented.

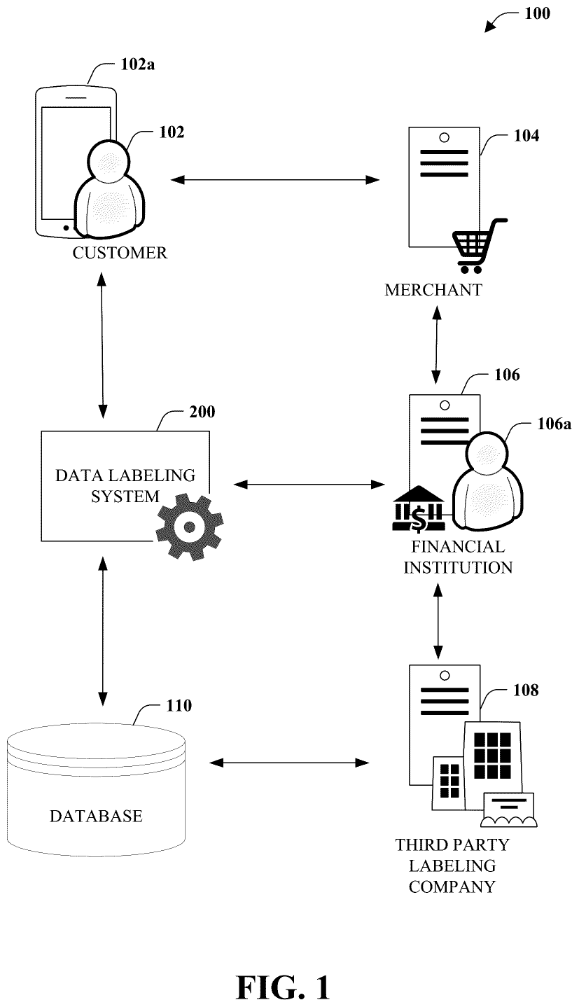

Referring to FIG. 1, an example implementation 100 is illustrated in accordance with one or more embodiments described herein. The example implementation 100 illustrates customer 102 and/or system of a customer, who may make a credit card purchase transaction with merchant 104 and/or system of a merchant. Upon purchase, a credit card is processed through a payment processor reaching a financial institution or financial institution server 106. The financial institution server 106 may receive information (e.g., raw merchant data) regarding the merchant 104. The raw merchant data may comprise merchant name, postal code, state, city, merchant category code (MCC), country, or a combination thereof. This raw merchant data may be processed through the data labeling system 200, and an application program interface (API) and machine learning may attempt to provide cleansed merchant information (e.g., labeled match) or merchant candidates for the customer 102 to view through a digital channel such as a mobile application via mobile device 102a (e.g., mobile phone). Almost instantaneously after a credit card purchase transaction is processed, the data labeling system 200 may also send the customer 102 an instant purchase alert. One of the benefits of having an instant purchase alert is that the customer or user is reminded almost immediately of the purchase, and even if the raw transaction data does not provide meaningful information, the purchase is still fresh in the user's mind to correlate the raw transaction data with the recent purchase.

Disclosed embodiments may utilize inferences, such as inferring omitted information. The terms “infer” and “inference” may refer to the process of reasoning about or inferring states of a system, a component, an environment, or a user from one or more observations captured by way of events or data, among other things. Inferences may be employed to identify a context or an action or may be used to generate a probability distribution over states, for example. An inference may be probabilistic. For example, computation of a probability distribution over states of interest may be based on a consideration of data or events. Inference may also refer to techniques employed for composing higher-level events from a set of events or data. Such inferences may result in the construction of new events or new actions from a set of observed events or stored event data, whether or not the events are correlated in close temporal proximity, and whether the events and data come from one or several events and data sources.

The data labeling system 200 may employ a multi-stage algorithm with deterministic rules and machine learning techniques to infer a match between raw merchant data (e.g., from raw transaction data) to merchant candidates, or generally the merchants. Initial datasets may come from third-party labeling company 108. However, it may be more cost-effective and potentially more accurate to use feedback from customers who made purchases that generate the raw transaction data. The data labeling system 200 may employ gradient boosting machines to generate models as well as new models. The data labeling system 200 may use deep learning to identify new model features based on feedback crowdsourced (e.g., received) from the customer 102 or customer service agent 106a. The feedback received from the customer 102 and the customer service agent 106a may be used as training data to retrain the models or create new models. Feedback from the customer 102, the customer service agent 106a, and datasets from the third-party labeling company 108 may be stored in database 110 for access by the data labeling system 200.

For example, the data labeling system 200 determines that the merchant candidates match the raw merchant data with a precision threshold (e.g., a 98% precision match), then the match may be displayed as a labeled match. However, because a 98% precision match may still result in millions of false positives, it is contemplated that the digital channels may provide the customer 102 with options to report problems, suggest edits, add descriptions, etc., to the merchant information. It is contemplated that the raw transaction data, including the raw merchant data, as it appears on the customer 102's financial statement should be displayed to the customer 102 to view through the digital channels even if there is a labeled match for the raw transaction data. This may provide a safeguard in case of labeling errors and as a way to receive updated information about the merchant if there is a change in the merchant information, such as a relocation, which may happen spontaneously and quickly due to unforeseen circumstances.

If the data labeling system 200 determines that the merchant candidates have confidence scores (e.g., model scores) below the precision threshold of 98%, then the top scoring (e.g., top 4, top 5, top 10, etc., highest scored) merchant candidates that meet the predetermined threshold of 0.8 or above may be selected for the customer 102 to answer in a multiple-choice question which merchant candidate matches the raw merchant data, or in a yes or no question whether the merchant candidate matches the raw merchant data. If no merchant candidates meet the predetermined threshold of 0.8 or above, then no merchant candidates are shown. Instead, in addition to showing the raw transaction data, the customer 102 may be asked to suggest a merchant name and provide any additional information about the merchant or add a description about the merchant. The customer 102 may also report a problem if the customer 102 does not recognize the purchase.

In some embodiments, the data labeling system 200 monitors a number of times a different user (e.g. other users or customers of the system) specifies the identified merchant name for the raw merchant name. The data labeling system 200 determines that the number of times satisfies an override threshold. The data labeling system 200 may override the machine learning model based on the override threshold being exceeded or satisfied. The data labeling system 200 may return the identified merchant name for the raw merchant name for confirmation by the customer 102. The confirmation can occur before an update of the machine learning model.

The ability to report a problem through digital channels may reduce the number of calls made to customer service agents, such as the customer service agent 106a. Customer service agents often receive feedback from customers calling in for credit card charges that they do not recognize. If calls are made to the customer service agent 106a, the customer service agent 106a may input feedback, including transaction description or details, they receive from the customer 102. The data labeling system 200 may receive the feedback directly from the customer 102 or via input by the customer service agent 106a. The data labeling system 200 may use this feedback to build, train, update, or retrain the models.

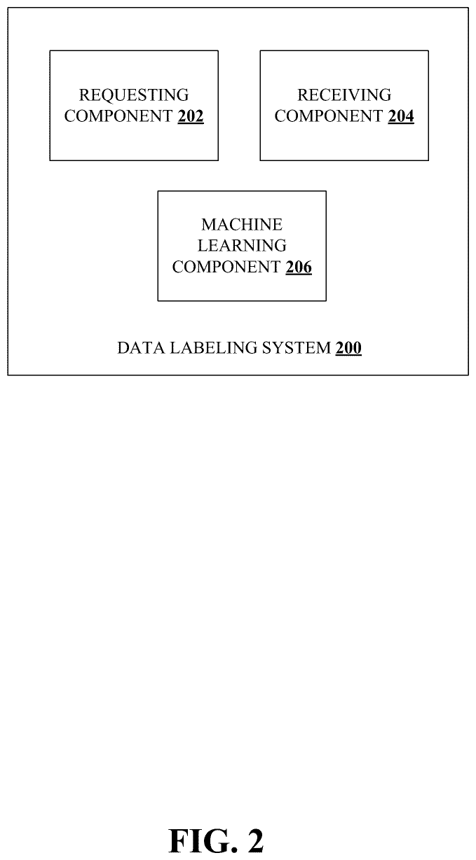

FIG. 2 illustrates a block diagram of an example, non-limiting data labeling system 200 in accordance with one or more embodiments described herein. The data labeling system 200 may comprise requesting component 202, receiving component 204, and machine learning component 206. The requesting component 202, receiving component 204, and/or machine learning component 206 may be a hardware processor, software module, software machine, a combination, and/or the like. The requesting component 202 may request merchant information from the customer 102 or the customer service agent 106a (e.g., via a web application similar to what is displayed for the customer 102) to crowdsource the merchant information for raw transaction data comprising raw merchant data (e.g., to crowdsource the merchant information that matches the raw merchant data in the raw transaction data). The receiving component 204 may receive, from the customer 102 or the customer service agent 106a, the merchant information comprising a selected response regarding a merchant candidate or a data entry of the merchant information corresponding to the raw merchant data (e.g., comprising postal code, state, city, merchant category code (MCC), country, or a combination thereof). The merchant information requested and the merchant information received from the customer 102 may also comprise requesting and receiving uploaded receipts of credit card transactions with the merchant information, which may be used to increase the confidence of the feedback (e.g., response, input, data entry, etc.) received from the customer 102 regarding the merchant information. A selected response may be a yes or no response, a multiple-choice response, or a none-of-the-above response. A negative response such as the no response or the none-of-the-above response may lower (e.g., via the machine learning component 206) the confidence scores of the merchant candidates that are part of the negative response.

The customer may request the merchant information may through a digital channel such as a web application, mobile application, push notification, text message, email, or a combination thereof. The request for the merchant information from the customer 102 may be made via an instant purchase alert (e.g., electronic alert, push notification, text message, email, etc.) sent within a predetermined amount of time after a purchase is made. In some embodiments, the electronic alert or instant purchase alert is transmitted in real or near real time of a transaction of the user or customer. The merchant candidates may have a confidence score of a predetermined threshold of 0.8 or above but do not meet precision threshold of 98% and be selected, to be presented to the customer 102, among the one or more merchant candidates with the highest confidence score. For example, the top 5 (or top 3, 4, 10, etc.) merchant candidates with the highest confidence score that meets the predetermined threshold of 0.8 or above may be selected as part of the multiple-choice question or the yes or no question. The merchant candidates having a precision threshold of 98% or above may be shown as a labeled match. The merchant candidates that do not meet the predetermined threshold of 0.8 or above may be not shown (e.g., not used). However, an option to submit feedback may be provided if no merchant candidates are shown. If a certain merchant candidate is selected (e.g., via multiple-choice questions, yes or no questions, etc.) or certain merchant information is submitted (e.g., via a data entry, freeform data entry, etc.) by a predetermined number of customers, the machine learning component 206 may automatically match the certain merchant candidate or the certain merchant information with the raw merchant data using an override with deterministic logic and automatically update the cache keys to show the certain merchant candidate or the certain merchant information, as an interim before the models are retrained with the automatically matched merchant candidate or with the automatically matched merchant information.

The machine learning component 206 may match the raw merchant data to the merchant candidate, or the merchant information entered by the customer 102 or the customer service agent 106a, by employing a multi-stage algorithm with deterministic rules and machine learning techniques. The machine learning component 206 may also invoke deep learning or deep learning model coupled with gradient boosting machines to identify new model features based on feedback crowdsourced from the customer 102 or received by the customer service agent 106a and generate models comprising one or more merchant candidates to match with the raw merchant data. More specifically, deep learning may be employed to identify new model features and gradient boosting machines may be employed to generate new models. Deep learning may be a deep neural network (“DNN”), convolutional neural network (“CNN”), long short-term memory recursive neural network (“LSTM-RNN”), or a Convolutional, Long Short-Term Memory Deep Neural Network (“CL-DNN”). Deep learning includes one or more layers to create an artificial neural network for determining new model features and/or new models.

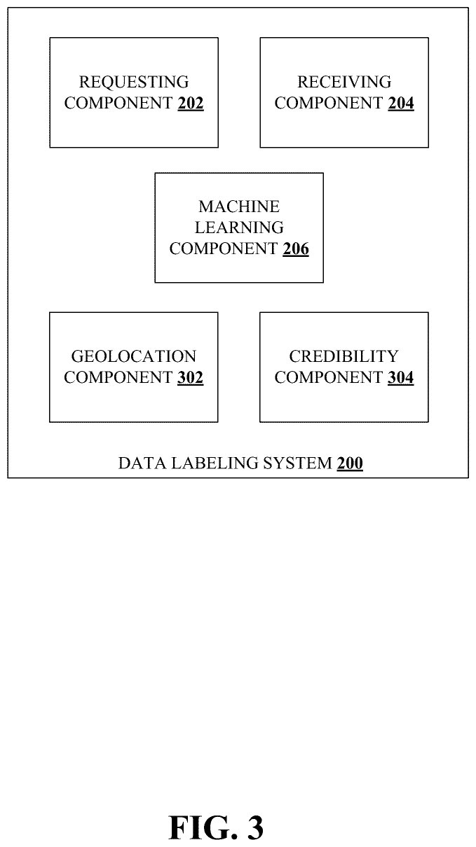

FIG. 3 illustrates a block diagram of another example, non-limiting data labeling system 200, in accordance with one or more embodiments described herein. The data labeling system 200 may further comprise geolocation component 302 and credibility component 304. The geolocation component 302, and/or credibility component 304 may be a hardware processor, software module, software machine, a combination, and/or the like. The geolocation component 302 may detect geolocation data of credit card transactions of the customer 102, as permitted by the customer 102. If a transaction is made in person with a credit card present, the location of the point of sale (POS) may be assessed. Based on the location of the POS, the merchant information provided by the customer 102 may be verified by identifying whether that merchant is located at the location of the POS. The location of a POS may be, at times, missing from the raw transaction data that is transferred to the financial institution server 106. Therefore, if the location of the customer 102 may be tracked, that may provide the location information missing from the raw transaction data. Additionally, tracked location information of the customer 102 may also be used to confirm that the customer 102 is present at the time of a credit card transaction to prevent fraud.

An instant purchase alert may be sent to the customer 102 to confirm whether the customer 102 is present during a credit card transaction, whether in person or online, or to inform the customer 102 of a transaction that was made without the presence of the customer 102 detected. Location of the customer 102 may also be tracked by the geolocation component 302 (e.g., via a mobile app) to confirm that the customer 102 is present at the time of an in-person credit card transaction or an online transaction. It is appreciated that the geolocation tracking in the geolocation component 302 may be used to decline credit card transactions if the presence of the customer 102 is not detected at the time of the credit card transactions. The geolocation component 302 may track and record location of a mobile device (e.g., mobile phone) associated with the customer 102 via a mobile application. Being able to verify the location of a transaction may increase the credibility of a customer's feedback.

The credibility component 304 may rate the customer 102 on credibility based on the accuracy of the merchant information provided and other factors such as uploading contents of receipts of credit card transactions or sharing geolocation for detection of location during the credit card transactions. The credibility of the feedback from the customer 102 may increase as the number of accurate feedback increases. The credibility (e.g., confidence, confidence score, credibility score, or user credibility score) of a feedback (e.g., from the customer 102 or from the customer service agent 106a on behalf of the customer 102) may also increase if the feedback may be verified with an uploaded receipt or with a shared geolocation. The user credibility score captures the likelihood that input of the user is correct. The user credibility score may be employed as a weight on the input from the customer or user when updating the machine learning model. The credibility score may be affected by the content of an uploaded receipt. For example, verifying a merchant name on the uploaded receipt to the customer feedback or input.

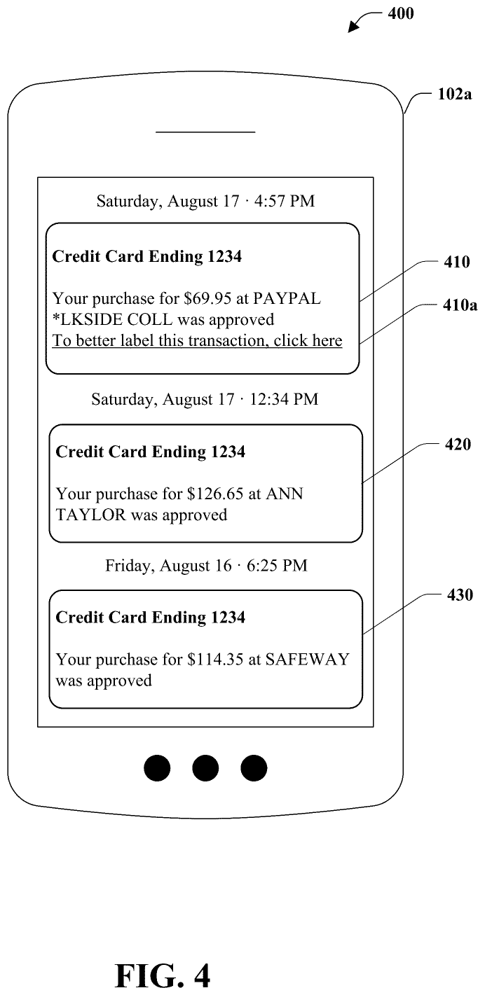

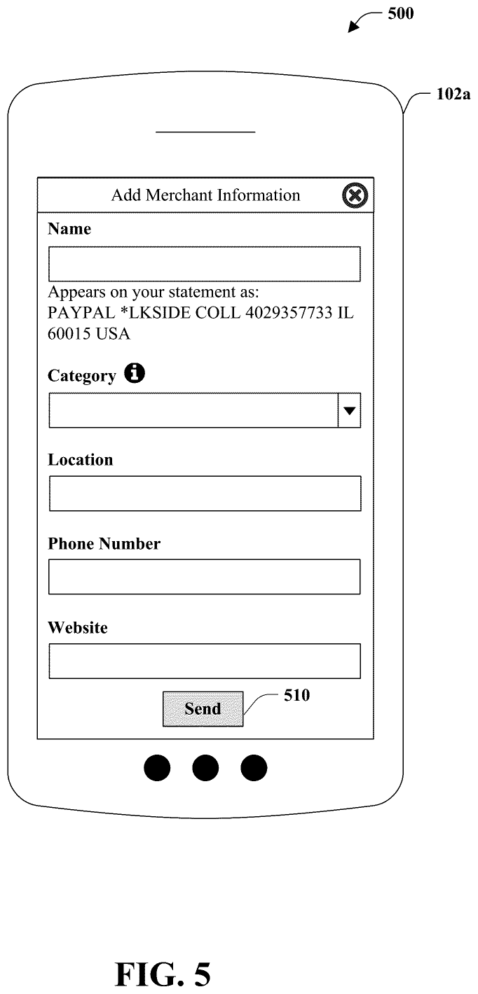

FIGS. 4 through 14 illustrate non-limiting user interface (UI) examples on the mobile device 102a. These UI examples may also be used on other types of electronic devices such as a tablet, laptop, or desktop computer in some embodiments. FIG. 4 illustrates an example, non-limiting mobile credit card notification 400, in accordance with one or more embodiments described herein. The mobile credit card notification 400 may comprise short message service (SMS) text messages such as instant purchase alert 410, instant purchase alert 420, and instant purchase alert 430. The instant purchase alerts 410, 420, 430 may be sent to the customer 102 upon processing of a credit card transaction. The customer 102 may be notified shortly after a credit card transaction is processed and the customer 102 would be able to correlate if that transaction belongs to the customer 102 based on the timing of the notification and the purchase amount even if the merchant name of the merchant does not provide meaningful significance. For example, the instant purchase alert 410 notifies the customer 102 that a credit card ending 1234 was used to make a purchase on Saturday, August 17 at around 4:57 PM at PAYPAL *LKSIDE COLL (e.g., a raw merchant name or a raw merchant data) for $69.95. The timing of the instant purchase alert 410 may be close in time (e.g., within minutes or seconds) to the credit card transaction, which would help the customer 102 to recognize this transaction if the customer 102 did, in fact, make a credit card transaction at that time for the stated amount of $69.95 even if the customer 102 would normally not recognize the raw merchant name PAYPAL *LKSIDE. The instant purchase alert 410 may also provide linked text 410a stating, “To better label this transaction, click here” in order to crowdsource information from the customer 102 regarding the merchant information for that credit card transaction. The linked text 410a may open to another page, as illustrated in FIG. 5 (discussed below).

The instant purchase alert 420 notifies the customer 102 of a purchase made with a credit card ending 1234 on Saturday, August 17 at around 12:34 PM at Ann Taylor for $126.65. Similarly, the instant purchase alert 430 notifies the customer 102 of a purchase using a credit card ending 1234 for $114.35 at Safeway on Friday, August 16, at around 6:25 PM. The instant purchase alerts 420 and 430 state that the merchants are Ann Taylor and Safeway, respectively, which may be called a labeled match. It is contemplated that labeled match may benefit by providing a linked text similar to linked text 410a may be beneficial because sometimes merchant information may change suddenly, especially if there is a relocation.

FIG. 5 illustrates an example, non-limiting merchant information form 500 in accordance with one or more embodiments described herein. The merchant information form 500 may request the customer 102 to provide feedback on merchant information such as name (e.g., merchant name), category (e.g., shopping, dining, etc.), location (e.g., address), phone number, and website. The customer 102 may fill out the requested information and click on send button 510 to submit the requested merchant information. It is appreciated that because the merchant information form 500 is provided in the linked text 410a as part of the instant purchase alert 410 upon the credit card transaction, this may allow the customer 102 to input merchant information when the customer 102 deem convenient. For example, some customers may find that providing merchant information right after a purchase is more convenient as the purchase receipts are still on hand.

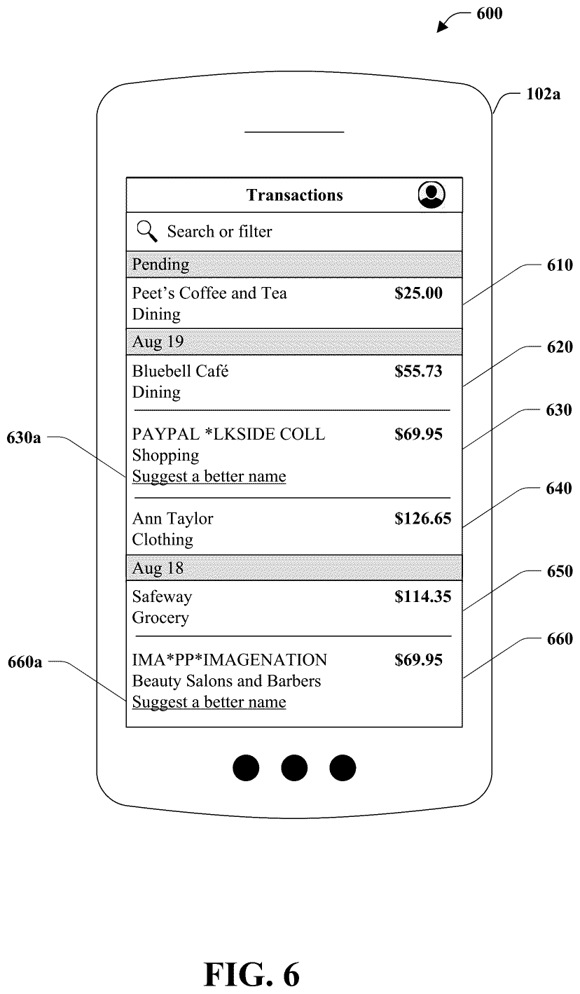

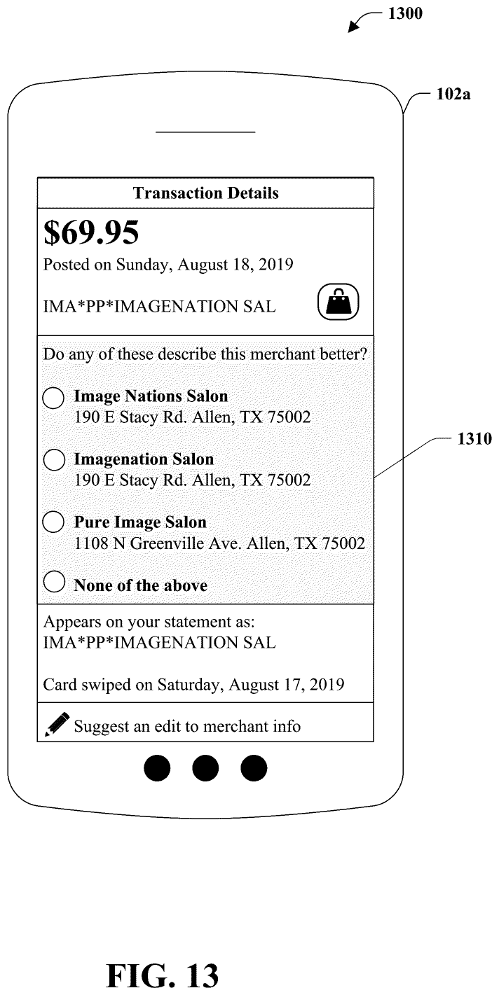

FIG. 6 illustrates an example, non-limiting transaction history 600 in accordance with one or more embodiments described herein. The transaction history 600 may be a credit card transaction history of the customer 102 as viewed on mobile device 102a. The transaction history 600 may list cleansed merchant names (e.g., labeled match) such as in transaction 610 (e.g., Peet's Coffee and Tea), transaction 620 (e.g., Bluebell Café), transaction 640 (e.g., Ann Taylor), and transaction 650 (e.g., Safeway). The transaction history 600 may also list raw merchant names such as in transaction 630 (e.g., PAYPAL *LKSIDE COLL) and transaction 660 (e.g., IMA*PP*IMAGENATION). The transaction 630 and the transaction 660 may have linked text 630a and linked text 660a, respectively, to ask (e.g., crowdsource) the customer 102 to “suggest a better name” for those raw merchant names. FIGS. 5, 7, 8, 9, 10, and 13 illustrate example pages, opened from linked texts, for the customer 102 to provide feedback on merchant information. In non-limiting examples, linked text 630a may open example pages illustrated in FIGS. 5, 7, 8, 9, and 10, and linked text 660a may open to example page illustrated in FIG. 13.

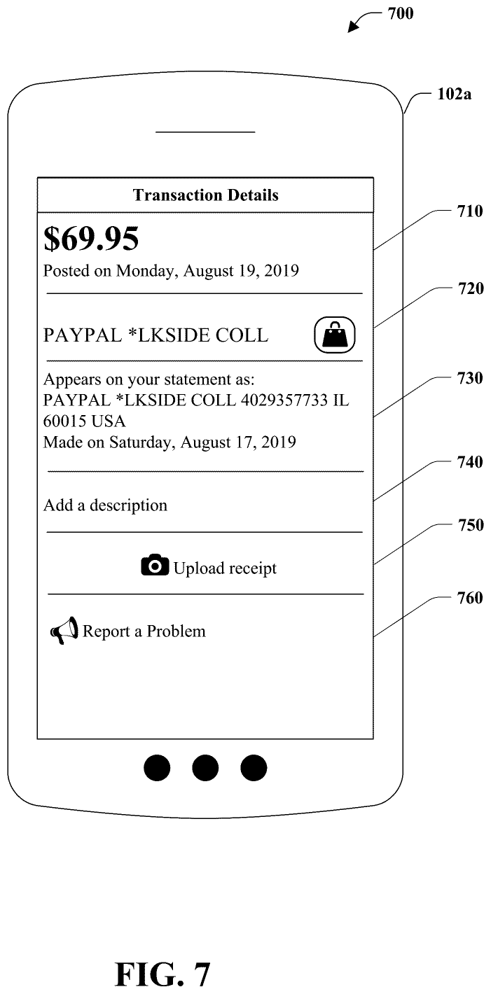

FIG. 7 illustrates an example, non-limiting transaction details 700 in accordance with one or more embodiments described herein. Detail 710 shows transaction 630 having a transaction amount of $69.95 with a posted date of Aug. 19, 2019. Although the posted date is Aug. 19, 2019, detail 730 shows that the transaction was made on Aug. 17, 2019. If the customer 102 does not recognize the merchant name shown in detail 720 and sees only the posted date of Aug. 19, 2019, the customer 102 may be confused not recognizing the merchant name or the posted date because the transaction was made on a different day. This is an example why having an instant purchase alert such as mobile credit card notification 400 may be helpful. If the customer 102 has descriptions about the merchant to add, the customer 102 may be encouraged to add a description into input field 740. In some embodiments, the input field 740 may be a text box and/or the like. The customer 102 may also upload a receipt in file input 750. If the customer 102 does not recognize the transaction details 700 and believes there is a problem, the customer 102 may report a problem using input form 760.

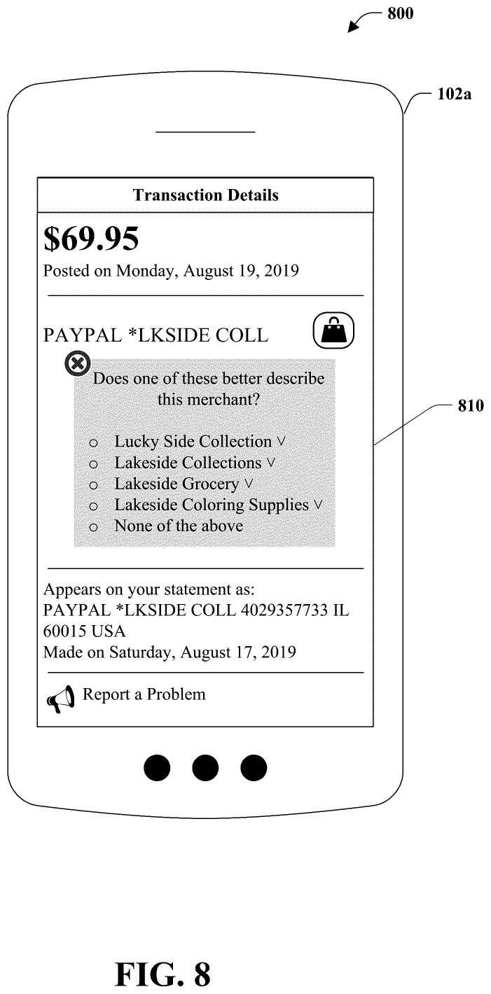

FIG. 8 illustrates another example, non-limiting transaction details 800 in accordance with one or more embodiments described herein. Transaction details 800 may crowdsource merchant information from the customer 102 using multiple choice question 810, instead of asking the customer 102 to enter the merchant information as with input field 740 illustrated in FIG. 7. Multiple choice questions may be easier to respond to than open questions and, therefore, may receive a higher response rate from customers. Additional merchant information such as merchant address may be shown in the multiple-choice question 810 or may be viewed by clicking on the caret symbol (v) after the merchant names. If the customer 102 selects “None of the above,” that means the merchant names shown are not likely or less likely the correct merchant name. Therefore, the confidence score of those merchant names (e.g., merchant candidates) may be reduced. It is appreciated that the features in the different examples illustrated in the figures may be mixed and matched. For example, input field 704, file input 750, and multiple-choice question 810 may be employed together on the same UI.

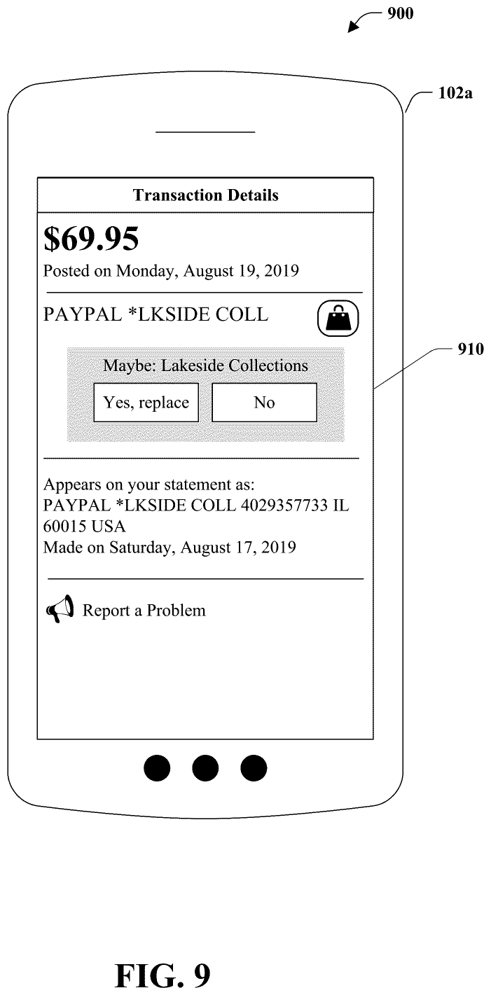

FIG. 9 illustrates another example, non-limiting transaction details 900 in accordance with one or more embodiments described herein. The transaction details 900 may comprise yes or no question 910 asking if the suggested merchant name (e.g., merchant candidate), “Maybe: Lakeside Collections,” is the correct merchant name. If the answer is a no, the confidence score of this merchant name or merchant candidate (“Lakeside Collections”) may be lowered. If a predetermined number of customers select yes that the suggested merchant name or merchant candidate is the correct merchant, the output may be automatically updated to show that this is the matched merchant (e.g., a labeled match). An override with deterministic logic may be used to automatically match the merchant candidate to the merchant (e.g., matching Lakeside Collections to “PAYPAL *LKSIDE COLL”) and the cache key may be automatically updated to show the correct merchant.

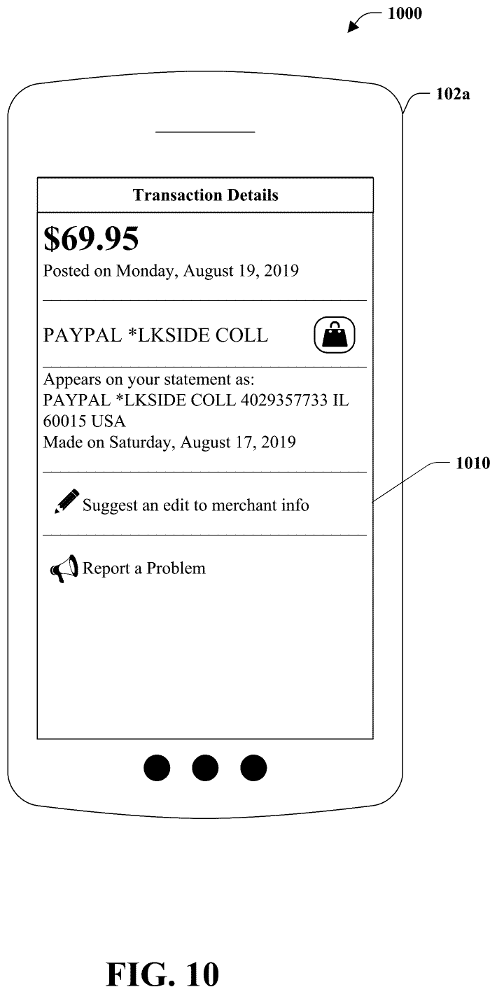

FIG. 10 illustrates another example, non-limiting transaction details 1000 in accordance with one or more embodiments described herein. Transaction details 1000 may comprise input field 1010 asking the customer 102 to “Suggest an edit to merchant info.” The input field 1010 may be a freeform data entry for the customer 102 to enter any number of merchant information the customer wishes to enter. In some embodiments, the input field 1010 may be a text box and/or the like. It is appreciated that the wording of the request in the input field 1010 may be phrased differently.

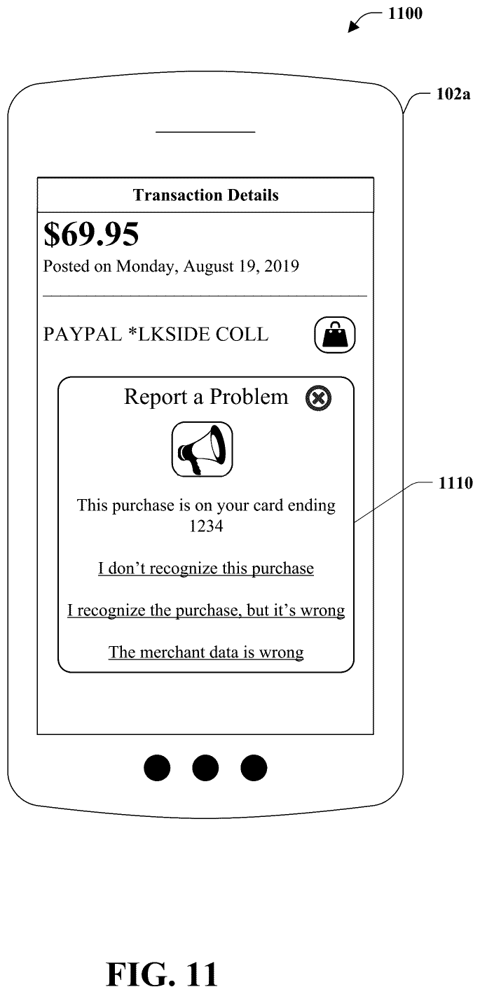

FIG. 11 illustrates another example, non-limiting transaction details 1100 in accordance with one or more embodiments described herein. If the customer 102 report a problem such as using input form 760, pop-up 1110 may be displayed asking the customer 102 if the problem is whether the customer 102 does not recognize the purchase (e.g., “I don't recognize this purchase”), whether the purchase is wrong (e.g., “I recognize the purchase, but it's wrong”), or whether “The merchant data is wrong.” The customer 102 may select and submit one of those choices. It is appreciated that pop-up 1110 may also be a freeform data entry for the customer 102 to enter the issues in the words of the customer 102.

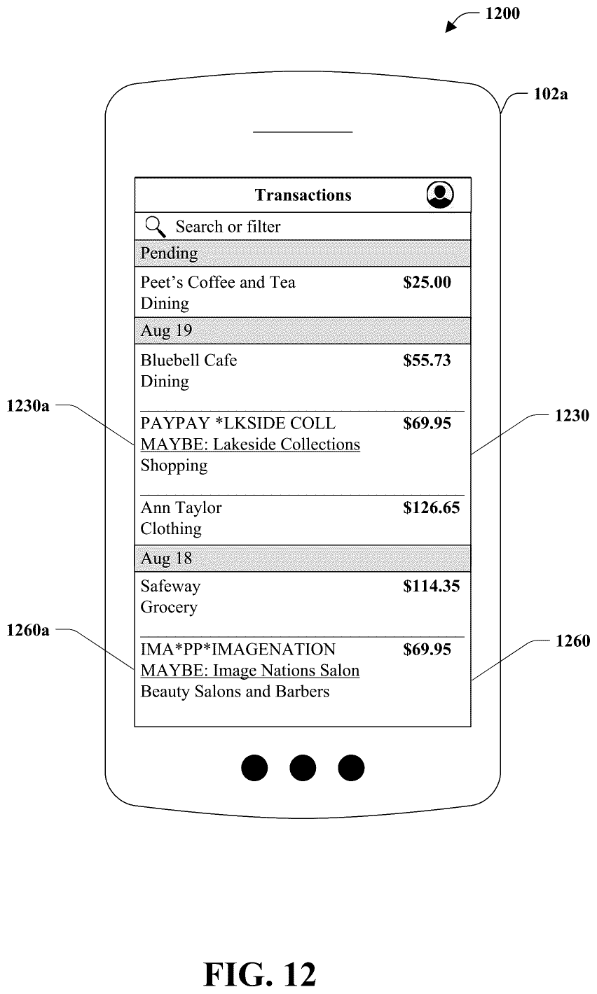

FIG. 12 illustrates another example, non-limiting transaction history 1200 in accordance with one or more embodiments described herein. The transaction history 1200 may comprise transaction 1230 and transaction 1260. The transaction 1230 may comprise linked text 1230a (e.g., “MAYBE: Lakeside Collections”), suggesting to the customer 102 that maybe the merchant name is Lakeside Collections. The transaction 1260 may comprise linked text 1260a (e.g., “MAYBE: Image Nations Salon”), suggesting to the customer 102 that maybe the merchant name is Image Nations Salon.

FIG. 13 illustrates another example, non-limiting transaction details 1300 in accordance with one or more embodiments described herein. The linked text 1260a may open to a page displaying the transaction details 1300 comprising multiple choice question 1310. The multiple-choice question 1310 may provide the customer 102 with different merchant candidates comprising of names and addresses to choose from (e.g., Image Nations Salon, 190 E Stacy Rd. Allen, TX 75002; Imagenation Salon, 190 E Stacy Rd. Allen, TX 75002; Pure Image Salon, 1108 N Greenville Ave. Allen, TX 75002). The customer 102 may also choose “None of the above,” however, this selection may lower the confidence score of the listed merchant candidates as it makes it less likely that the listed merchant candidates include the correct merchant information.

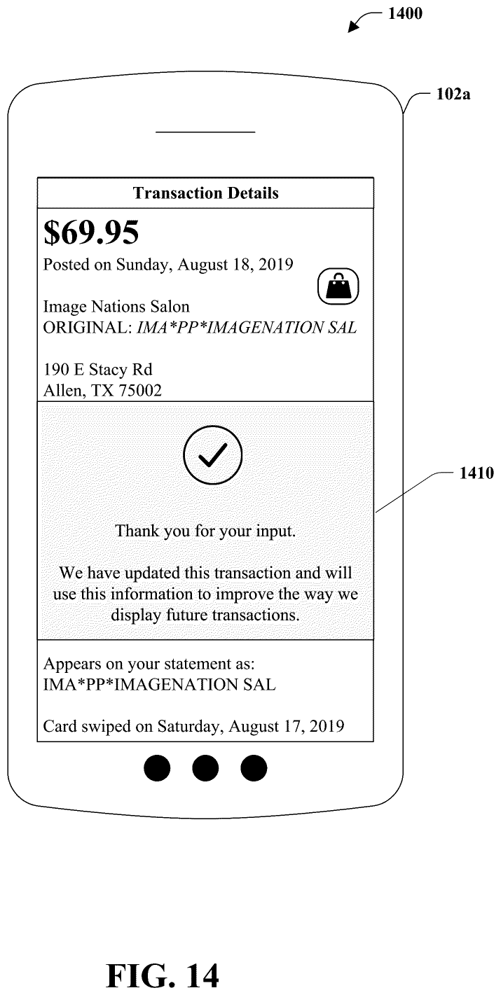

FIG. 14 illustrates another example, non-limiting transaction details 1400 in accordance with one or more embodiments described herein. The transaction details 1400 may comprise thank you message 1410, or another variation, for the customer 102 for providing feedback regarding the merchant or for reporting a problem regarding a transaction detail. The purpose of the thank you message 1410 is to thank the customer 102 and also to show the customer 102 confirmation that the feedback input by the customer 102 has been submitted.

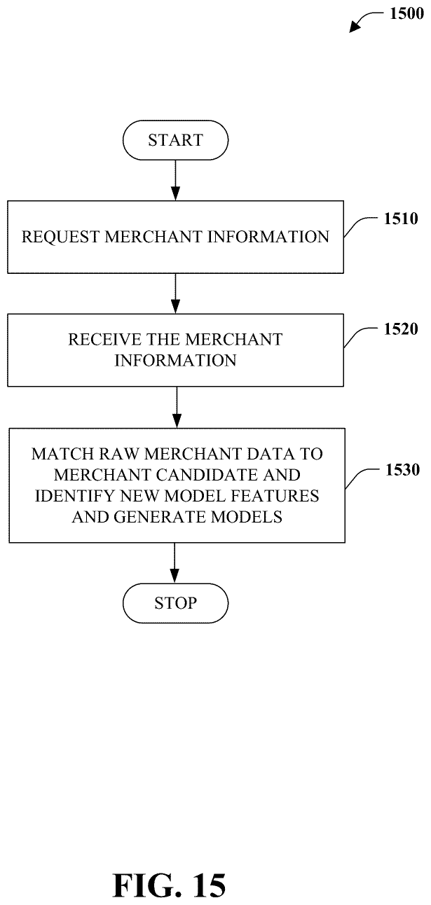

With reference to FIGS. 15, 16, and 17, example, non-limiting computer-implemented methods 1500, 1600, and 1700 are depicted. While, for purposes of simplicity of explanation, the methodologies shown herein, e.g., in the form of flow diagrams, are shown and described as a series of acts, it is to be understood and appreciated that the disclosed embodiments is not limited by the order of acts, as some acts may occur in a different order and/or concurrently with other acts from that shown and described herein. For example, those skilled in the art will understand and appreciate that a methodology could alternatively be represented as a series of interrelated states or events, such as in a state diagram. Moreover, disclosed embodiments may not implement all illustrated acts.

FIG. 15 illustrates a flow diagram of an example, non-limiting computer-implemented method 1500 in accordance with one or more embodiments described herein. At step 1510, the computer-implemented method 1500 may comprise requesting (e.g., via the requesting component 202), by the data labeling system 200 operatively coupled to a processor (e.g., processor(s) 1810), merchant information from the customer 102 or the customer service agent 106a to crowdsource the merchant information to cleanse raw transaction data comprising raw merchant data. For example, the data labeling system 200 sends an electronic alert to a device of a customer to request the user to identify a merchant name.

At step 1520, the computer-implemented method 1500 may comprise receiving (e.g., via the receiving component 204), by the data labeling system 200, from the customer 102 or the customer service agent 106a, the merchant information comprising a selected response regarding a merchant candidate or a data entry of the merchant information corresponding to the raw merchant data. In the example, the data labeling system 200 may receive a response from the customer via the user device such as the customer providing an input of the merchant name via the user device.

At step 1530, the computer-implemented method 1500 may comprise matching (e.g., via the machine learning component 206), by the data labeling system 200, the raw merchant data to the merchant candidate. The data labeling system 200 may employ a multi-stage algorithm with deterministic rules and machine learning techniques. The data labeling system 200 may invoke deep learning coupled with gradient boosting machines to identify new model features based on feedback crowdsourced from the customer 102 or received by the customer service agent 106a. The data labeling system 200 may generate models comprising one or more merchant candidates to match with the raw merchant data. For example, the data labeling system 200 can update the model with the response from the customer of matching the raw merchant data to a merchant candidate.

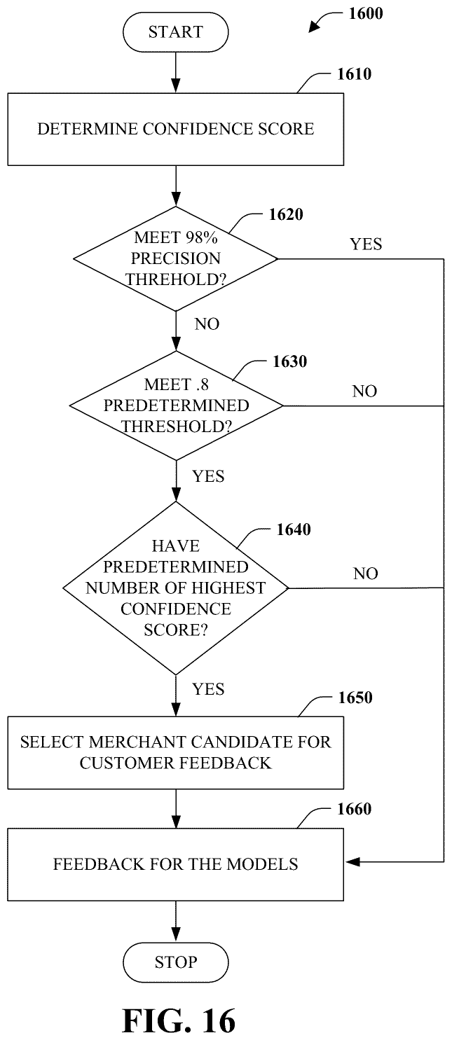

FIG. 16 illustrates another flow diagram of an example, non-limiting computer-implemented method 1600 in accordance with one or more embodiments described herein. At step 1610, the computer-implemented method 1600 may comprise determining (e.g., via the machine learning component 206), by the data labeling system 200, confidence score of merchant candidates. For example, the data labeling system 200 can determine a confidence score that the model is correct in matching a merchant candidate to the raw merchant data.

At step 1620, the computer-implemented method 1600 may comprise determining (e.g., via the machine learning component 206), by the data labeling system 200, whether the confidence score of the merchant candidates meet a precision threshold, for example, a 98% precision threshold. If yes, the merchant candidates are determined to be a labeled match. If no, the process continues to 1630. The data labeling system 200 compares the confidence score to the precision threshold to determine whether the merchant candidate should be shown to the customer.

At step 1630, the computer-implemented method 1600 may comprise determining (e.g., via the machine learning component 206), by the data labeling system 200, whether the merchant candidates meet a predetermined threshold, for example a 0.8 predetermined threshold. If yes, the process continues to 1640. The data labeling system 200 determines that the confidence score meets a predetermined threshold to a highest confidence score.

At step 1640, the computer-implemented method 1600 may comprise determining (e.g., via the machine learning component 206), by the data labeling system 200, whether the merchant candidates are within a predetermined number of highest confidence score (e.g., top highest confidence score). If yes, the process continues to 1650. The data labeling system 200 determines merchant candidates that are closest to the highest confidence scoring merchant candidate.

At step 1650, the computer-implemented method 1600 may comprise selecting (e.g., via the machine learning component 206), by the data labeling system 200, the merchant candidates for customer feedback (e.g., asking the customer 102 whether the merchant candidate or which of the merchant candidates match the raw transaction data comprising the raw merchant data).

At step 1660, the computer-implemented method 1600 may comprise analyzing (e.g., via the machine learning component 206), by the data labeling system 200, the feedback for training the models, generating new models, or identifying new model features. The data labeling system 200 can analyze the customer feedback to further develop the model for future merchant candidate predictions.

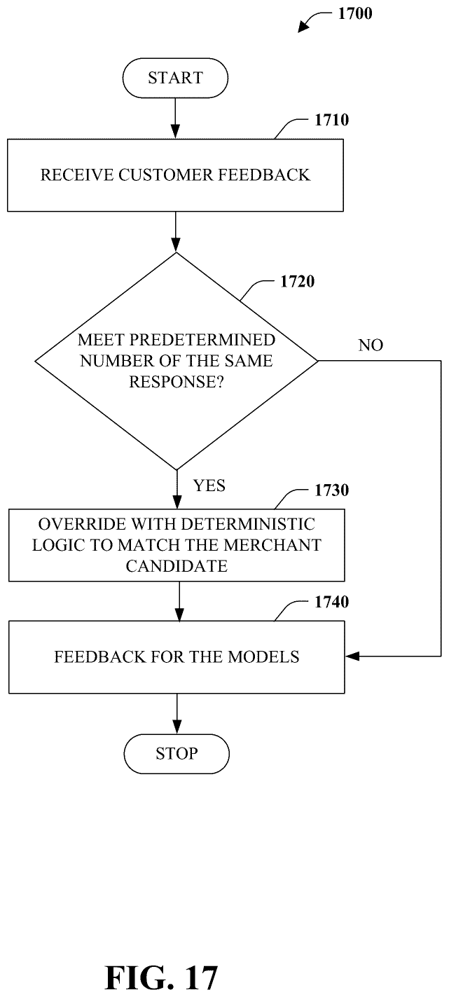

FIG. 17 illustrates another flow diagram of an example, non-limiting computer-implemented method 1700 in accordance with one or more embodiments described herein.

At step 1710, the computer-implemented method 1700 may comprise receiving (e.g., via the receiving component 204), by the data labeling system 200, customer feedback, from the customer 102 or the customer service agent 106a, of the merchant information comprising a selected response regarding a merchant candidate or a data entry of the merchant information corresponding to the raw merchant data. The data labeling system 200 can receive the customer feedback from a system of the customer and/or different users.

At step 1720, the computer-implemented method 1700 may comprise determining (e.g., via the machine learning component 206), by the data labeling system 200, whether the feedback from the customers meet a predetermined number of the same response (e.g. number of times) by the customers (e.g., a predetermined number of customers provided the same merchant information for the same merchant data). If yes, the process continues to 1730. The data labeling system 200 can compare multiple responses to each other to determine a consensus of merchant information or name.

At step 1730, the computer-implemented method 1700 may comprise automatically matching (e.g., via the machine learning component 206), by the data labeling system 200, the merchant information (e.g., merchant candidate) selected from the feedback, by the customer 102 or the customer service agent 106a, to the raw merchant data. The data labeling system 200 may use an override with deterministic logic and automatically update the cache keys to display the selected merchant information, as an interim before the models are updated or retrained with the selected merchant information.

At step 1740, the computer-implemented method 1700 may comprise analyzing (e.g., via the machine learning component 206), by the data labeling system 200, the feedback, by the customer 102 or the customer service agent 106a on behalf of the customer 102, for training the models, generating new models, or identifying new model features. The data labeling system 200 may update the models with analyzed data for future identifications.

As used herein, the terms “component” and “system,” as well as various forms thereof (e.g., components, systems, sub-systems) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

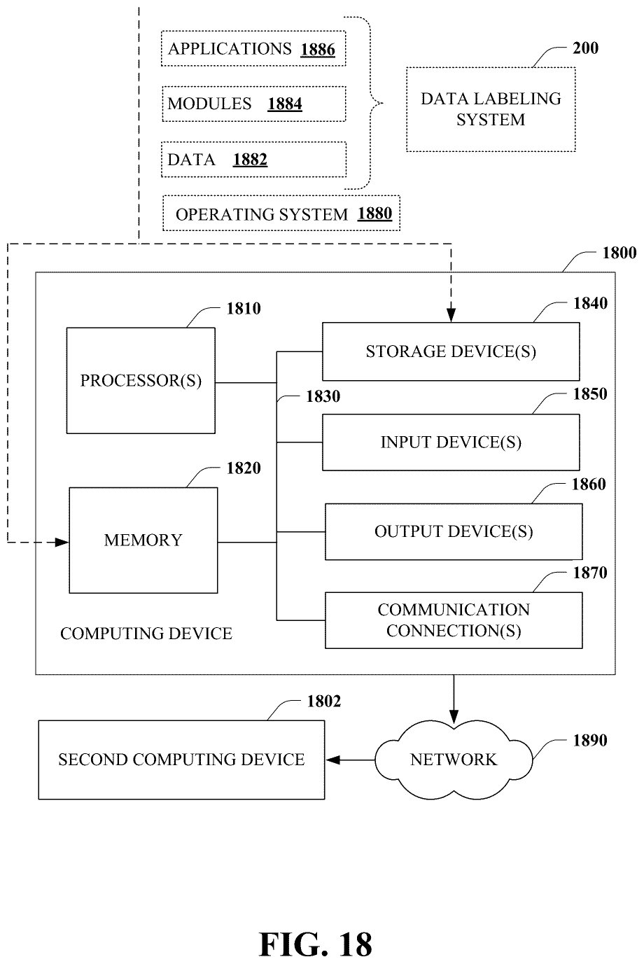

To provide a context for the disclosed subject matter, FIG. 18 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 18, illustrated is an example computing device 1800 (e.g., desktop, laptop, tablet, watch, server, hand-held, programmable consumer or industrial electronics, set-top box, game system, compute node . . . ). The computing device 1800 includes one or more processor(s) 1810, memory 1820, system bus 1830, storage device(s) 1840, input device(s) 1850, output device(s) 1860, and communications connection(s) 1870. The system bus 1830 communicatively couples at least the above system constituents. However, the computing device 1800, in its simplest form, can include one or more processors 1810 coupled to memory 1820, wherein the one or more processors 1810 execute various computer executable actions, instructions, and or components stored in the memory 1820.

The processor(s) 1810 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1810 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 1810 can be a graphics processor unit (GPU) that performs calculations with respect to digital image processing and computer graphics.

The computing device 1800 can include or otherwise interact with a variety of computer-readable media to facilitate control of the computing device to implement one or more aspects of the disclosed subject matter. The computer-readable media can be any available media that is accessible to the computing device 1800 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM), magnetic storage devices (e.g., hard disk, floppy disk, cassettes, tape, optical disks (e.g., compact disk (CD), digital versatile disk (DVD), and solid state devices (e.g., solid state drive (SSD), flash memory drive (e.g., card, stick, key drive)), or any other like mediums that store, as opposed to transmit or communicate, the desired information accessible by the computing device 1800. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 1820 and storage device(s) 1840 are examples of computer-readable storage media. Depending on the configuration and type of computing device, the memory 1820 may be volatile (e.g., random access memory (RAM)), nonvolatile (e.g., read only memory (ROM), flash memory) or some combination of the two. By way of example, the basic input/output system (BIOS), including basic routines to transfer information between elements within the computing device 1800, such as during start-up, can be stored in nonvolatile memory, while volatile memory can act as external cache memory to facilitate processing by the processor(s) 1810, among other things.

The storage device(s) 1840 include removable/non-removable, volatile/nonvolatile storage media for storage of vast amounts of data relative to the memory 1820. For example, storage device(s) 1840 include, but are not limited to, one or more devices such as a magnetic or optical disk drive, floppy disk drive, flash memory, solid-state drive, or memory stick.

Memory 1820 and storage device(s) 1840 can include, or have stored therein, operating system 1880, one or more applications 1886, one or more program modules 1884, and data 1882. The operating system 1880 acts to control and allocate resources of the computing device 1800. Applications 1886 include one or both of system and application software and can exploit management of resources by the operating system 1880 through program modules 1884 and data 1882 stored in the memory 1820 and/or storage device(s) 1840 to perform one or more actions. Accordingly, applications 1886 can turn a general-purpose computer 1800 into a specialized machine in accordance with the logic provided thereby.

All or portions of the disclosed subject matter can be implemented using standard programming and/or engineering techniques to produce software, firmware, hardware, or any combination thereof to control the computing device 1800 to realize the disclosed functionality. By way of example and not limitation, all or portions of the data labeling system 200 can be, or form part of, the application 1886, and include one or more modules 1884 and data 1882 stored in memory and/or storage device(s) 1840 whose functionality can be realized when executed by one or more processor(s) 1810.

In accordance with one particular embodiment, the processor(s) 1810 can correspond to a system on a chip (SOC) or like architecture including, or in other words integrating, both hardware and software on a single integrated circuit substrate. Here, the processor(s) 1810 can include one or more processors as well as memory at least similar to the processor(s) 1810 and memory 1820, among other things. Conventional processors include a minimal amount of hardware and software and rely extensively on external hardware and software. By contrast, an SOC implementation of processor(s) 1810 may be more powerful, as such an implementation may embed hardware and software that enable particular functionality with minimal or no reliance on external hardware and software. For example, the data labeling system 200 and/or functionality associated therewith can be embedded within hardware in a SOC architecture.

The input device(s) 1850 and output device(s) 1860 can be communicatively coupled to the computing device 1800. By way of example, the input device(s) 1850 can include a pointing device (e.g., mouse, trackball, stylus, pen, touch pad), keyboard, joystick, microphone, voice user interface system, camera, motion sensor, and a global positioning satellite (GPS) receiver and transmitter, among other things. The output device(s) 1860, by way of example, can correspond to a display device (e.g., liquid crystal display (LCD), light emitting diode (LED), plasma, organic light-emitting diode display (OLED)), speakers, voice user interface system, printer, and vibration motor, among other things. The input device(s) 1850 and output device(s) 1860 can be connected to the computing device 1800 by way of wired connection (e.g., bus), wireless connection (e.g., Wi-Fi, Bluetooth), or a combination thereof.

The computing device 1800 can also include communication connection(s) 1870 to enable communication with at least a second computing device 1802 by means of a network 1890. The communication connection(s) 1870 can include wired or wireless communication mechanisms to support network communication. The network 1890 can correspond to a local area network (LAN) or a wide area network (WAN) such as the Internet. The second computing device 1802 can be another processor-based device with which the computing device 1800 can interact. For example, the computing device 1800 can correspond to a server that executes functionality of the data labeling system 200, and the second computing device 1802 can be a user device that communicates and interacts with the computing device 1800.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What has been described above includes examples of aspects of the disclosed embodiments. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system of cleansing raw data based on feedback, comprising:
a processor coupled to a memory that includes instructions that, when executed by the processor, cause the processor to:
identify raw merchant data that comprises a raw merchant name associated with a transaction of a user, wherein the raw merchant name is obscure;
infer a set of candidate merchant names that match the raw merchant name with a predetermined level of confidence with a machine learning model;
generate an electronic alert for the user to select a merchant name from the set of candidate merchant names associated with the transaction;
transmit the electronic alert to a device of the user within a predetermined time of the transaction;
receive an identified merchant name from the device of the user;
save the raw merchant name and the identified merchant name as training data; and
generate, after a predetermined period of time, an instruction to update the machine learning model based on the training data.

2. The system of claim 1, wherein the set of candidate merchant names is specified in a multiple choice format in the electronic alert.

3. The system of claim 1, wherein the identified merchant name is input by the user in a text box in the electronic alert.

4. The system of claim 1, wherein the instructions further cause the processor to:
monitor a number of times a different users specifies the identified merchant name for the raw merchant name;
determine that the number of times satisfies a threshold;
override the machine learning model; and
return the identified merchant name for the raw merchant name for confirmation before the update of the machine learning model.

5. The system of claim 1, wherein the machine learning model is a deep learning model.

6. The system of claim 1, wherein the instructions further cause the processor to add the identified merchant name on a statement of transactions for the user.

7. The system of claim 1, wherein the instructions further cause the processor to:
compute a user credibility score that captures a likelihood that input of the user is correct; and
employ the user credibility score as a weight on input from the user when updating the machine learning model.

8. The system of claim 7, wherein the user credibility score is affected by content of an uploaded receipt associated with the transaction.

9. The system of claim 7, wherein the user credibility score is affected based on shared geolocation data of a user device at the time of the transaction.

10. The system of claim 1, wherein the electronic alert is transmitted through at least one of a web application, mobile application, text message, or email.

11. The system of claim 1, wherein the electronic alert is transmitted in real or near real time of the transaction of the user.

12. A crowdsourcing method of raw transaction data cleansing, comprising:
executing, on a processor, instructions that cause the processor to perform operations associated with data cleansing, the operations comprising:
inferring, with a machine learning model, a set of candidate merchant names that match a raw merchant name with a predetermined level of confidence, wherein the raw merchant name is an obscure name;
generating an electronic alert that requests a user identify a merchant name from the set of candidate merchant names associated with a transaction;
transmitting the electronic alert to a device of the user within a predetermined time after the transaction; and
updating the machine learning model after a predetermined time with the raw merchant name and identified merchant name.

13. The method of claim 12, wherein the operations further comprise:
monitoring a number of times different users specify the identified merchant name for the raw merchant name;
determining that the number of times satisfies a threshold;
overriding the machine learning model; and
returning the identified merchant name for the raw merchant name for confirmation before the update of the machine learning model.

14. The method of claim 12, wherein the operations further comprise adding the identified merchant name on a statement of transactions for the user.

15. The method of claim 13, wherein the operations further comprise:
computing a user credibility score that captures a likelihood that input of the user is accurate; and
employing the user credibility score as a weight on user input from the user when retraining the machine learning model.

16. The method of claim 12, wherein the operations further comprise inferring the set of candidate merchant names with a deep learning model.

17. A crowdsourcing method of cleansing raw merchant transaction data, comprising:
inferring, with a machine learning model, a set of candidate merchant data that match raw merchant data associated with a purchase transaction of a user with a predetermined level of confidence;
generating an electronic alert that requests the user identify merchant data from the set of candidate merchant data associated with the purchase transaction;
transmitting the electronic alert to a device of the user within a predetermined time after the transaction; and
triggering an update of the machine learning model after a predetermined time with the raw merchant data and identified merchant data.

18. The crowdsourcing method of claim 17, further comprising
monitoring a number of times different users specify the identified merchant data for the raw merchant data;
determine that the number of times satisfies a threshold;
overriding the machine learning model; and
returning only the identified merchant data for the raw merchant data for confirmation before the update of the machine learning model.

19. The crowdsourcing method of claim 17, further comprising adding the identified merchant data on a statement of transactions for the user.

20. The crowdsourcing method of claim 17, wherein merchant data comprises at least one of merchant name, postal code, state, city, or merchant category code.
